(19) United States
(12) Patent Application Publication
(10) Pub. No.: US 2009/0309435 A1
(43) Pub. Date: Dec. 17, 2009

(54) Integrated Air Mover and Angular Position Sensor on Electric Motor

(75) Inventors: Takashi Shinano, Chatsworth, CA (US); Yoshio Sato, Schaumburg, IL (US); Scott Frankel, Gilbert, AZ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Minebea Co., Ltd., Nagano (JP)

(21) Appl. No.: 12/136,936

(22) Filed: Jun. 11, 2008

(51) Int. Cl. H02K 9/06

(52) U.S. Cl. 310/63

(57) ABSTRACT

Embodiments of the present invention provide an integrated air-mover and position sensor for an electric motor. One or more fins may be attached to a position sensor and adapted to generate a movement of air when the position sensor rotates with a rotor shaft. Such an arrangement not only allows the position sensor to sense positions of the electric motor, but also provides air-cooling functions for cooling the motor driver efficiently, thus improving product reliability. The position sensor may be an optical encoder or a capacitive sensor. Alternatively, one or more fins may be disposed within the electric motor and attached directly onto a rotor shaft of the electric motor to create a movement of air for cooling the motor driver directly and efficiently.

### BACKGROUND OF THE INVENTION

This invention relates generally to electric motors, and more particularly to techniques and systems that provide air-cooling functions for electric motors.

In the field of motion control, electric motors of the kind generally referred to as stepping motors (also known as “steppers”) are widely used in positioning applications and robotics to achieve high accuracy. It is common practice to use stepping motors with open-loop control (the driver has no feedback on where the rotor actually is) in low speed operations as a cost effective method and to use servo motors with closed-loop control (incorporating rotor position feedbacks) in high speed operations. In closed loop positioning applications, a rotary encoder such as an optical encoder may be used to detect a rotational position and speed of an electric motor. The detected information is used by a driver circuit to control the flow of current into the winding of the electric motor in order to achieve the desired position, speed, and direction of a rotation.

Typically, the driver circuit includes numerous electrical components that draw electrical current to perform their intended functions. For high speed close-loop operations, the driver circuit is required to handle a large amount of current. This electrical current flow produces heat. If the temperature exceeds a predetermined range, e.g., the drive circuit is too hot, the driver circuit may not function correctly, thereby potentially degrading the overall performance of the electric motor. An external heat sink may be used to dissipate the heat in the driver circuit. But such a heat sink significantly adds to the size of the electric motor system.

### BRIEF SUMMARY OF THE INVENTION

One of the objects of the present invention is to provide air-cooling functions using a position sensor. Another object is to provide air-cooling functions using the electric motor shaft.

Embodiments of the present invention provide an integrated air-mover and position sensor for an electric motor. According to an embodiment of the present invention, one or more fins may be attached to a position sensor and adapted to generate a movement of air when the position sensor rotates with a rotor shaft. Such an arrangement not only allows the position sensor to sense positions of the electric motor, but also provides air-cooling functions for cooling the motor driver efficiently, thus improving product reliability.

According to an embodiment of the present invention, the position sensor may be an optical encoder or a capacitive sensor.

According to an embodiment of the present invention, one or more fins may be disposed within the electric motor and attached directly onto a rotor shaft of the electric motor to create a movement of air for cooling the motor driver directly and efficiently.

Other features and advantages of the present invention will be apparent from the accompanying drawings and from the detailed description that follows below.

### BRIEF DESCRIPTION OF THE DRAWINGS

FIG. 1 is a simplified schematic representation of an electric motor system according to an embodiment of the present invention.

FIGS. 2-4 illustrate an optical encoder for an electrical motor system according to an embodiment of the present invention.

FIG. 5 illustrate a capacitive sensor plate for an electrical motor system according to an embodiment of the present invention.

FIG. 6 is a simplified schematic representation of an electric motor system according to an embodiment of the present invention.

FIG. 7 is a simplified schematic representation of an electric motor system according to an embodiment of the present invention.

### DETAILED DESCRIPTION OF THE INVENTION

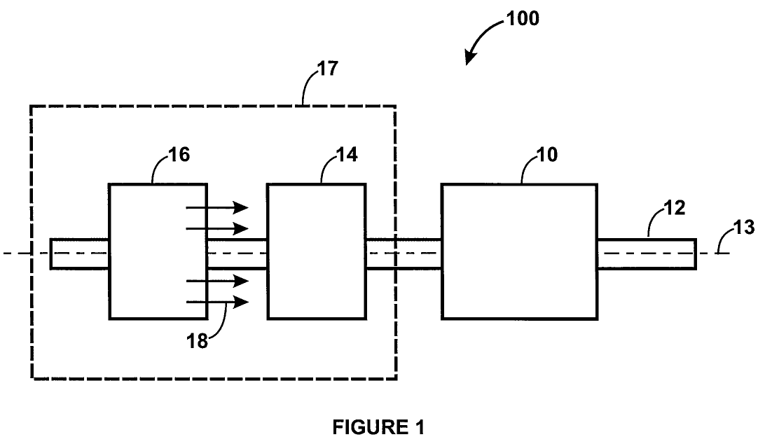

FIG. 1 is a simplified schematic representation of an electric motor system 100 according to an embodiment of the present invention. The various components depicted in electric motor system 100 are merely examples of components that may be included in an electric motor system. In alternate embodiments, electric motor system 100 may have less or more components than those shown.

Referring to FIG. 1, electric motor system 100 includes a motor 10, which is secured to a rotor shaft 12 for rotation about a central axis 13. A position sensor 16, which is coupled to motor 10 via rotor shaft 12, is provided to detect the position, speed, and direction of each motor rotation. The detected information is provided to a driver 14 for controlling the motor rotation. While position sensor 16 and driver 14 are illustrated as separate units in FIG. 1, it is understood that they may be implemented as a single unit 17.

In addition to sensing the motor's angular position, position sensor 16 in accordance with the present invention is adapted and configured to provide air-cooling functions to driver 14. As will be explained in more detail below, one or more fins (not shown in FIG. 1) may be attached to position sensor 16 to create a movement of air 18 across driver 14 when position sensor 16 rotates with rotor shaft 12 along central axis 13.

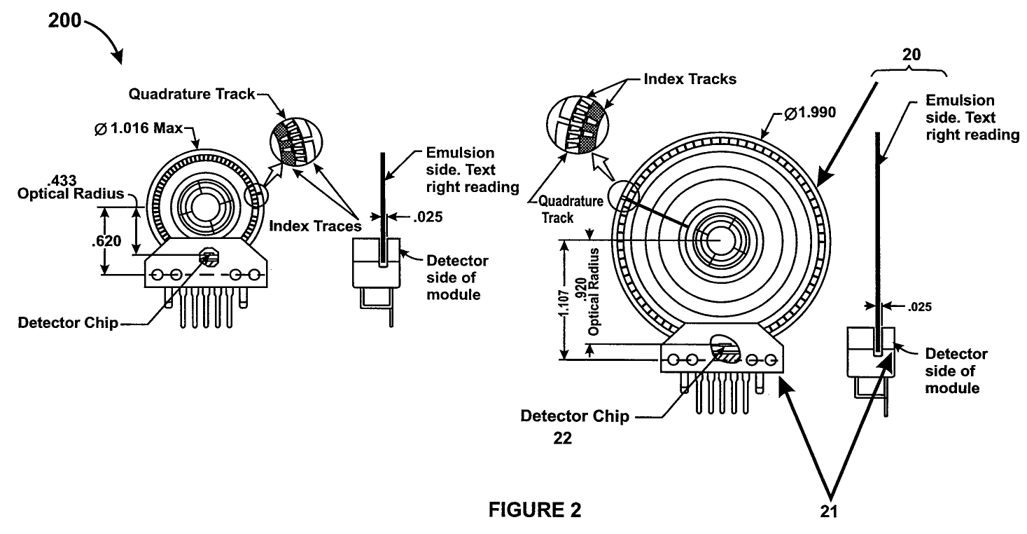

In one embodiment, position sensor 16 is an optical encoder, such as the HEDS series optical encoders manufactured and sold by Avago. In another embodiment, position sensor 16 is a capacitive sensor. These embodiments will be explained later in more detail with reference to FIGS. 2-5.

Alternatively, one or more fins may be disposed within the electric motor and attached directly onto a rotor shaft of the electric motor to create a movement of air for cooling the motor driver directly and efficiently.

FIG. 2 illustrates an optical encoder according to an embodiment of the present invention. Specifically, FIG. 2 shows an HEDS series of optical encoder 200 manufactured and sold by Avago that is designed to detect rotary position of an electric motor. Generally, optical encoder 200 may include an emulsion side 20 and a detector side 21. As shown in FIG. 2, detector side 21 of optical encoder 200 includes an LED detector chip 22 that detects the index and/or quadrature of each motor rotation.

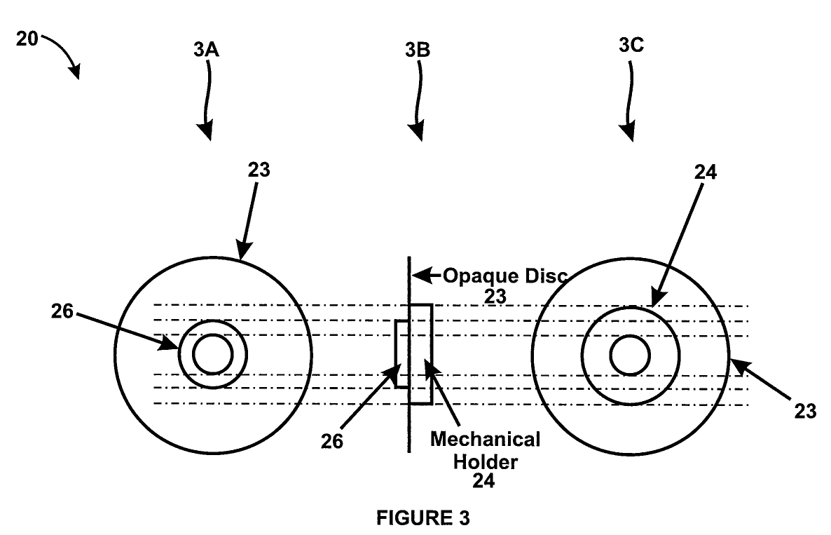

FIG. 3 illustrates an emulsion side 20 of the optical encoder of FIG. 2. Specifically, FIGS. 3A and 3C illustrate the front and back views of emulsion side 20, while FIG. 3B is a side view of emulsion side 20. Emulsion side 20 includes a circular opaque disc 23. A circular-shaped mechanical holder 24 and a circular-shaped ring 26 are respectively secured on opposite sides of the opaque disc. Such an arrangement allows opaque disk 23 to be securely fitted onto a rotor shaft, such as rotor shaft 12 of FIG. 1.

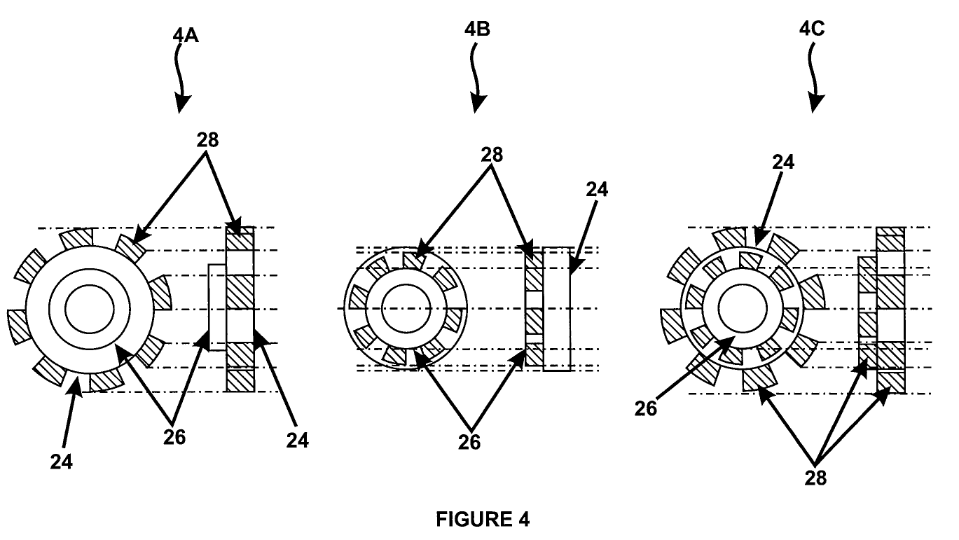

As mentioned previously, one or more fins may be included in the optical encoder to provide air-cooling functions. In one embodiment, such as shown in FIG. 4A (two views are illustrated in FIG. 4A, the right side of FIG. 4A is a side view, and the left side of FIG. 4A is a front/back view), one or more fins 28 are securely attached to the outer circumference of mechanical holder 24. When the rotor rotates about a rotor shaft, mechanical holder 24 also rotates. As such, fins 28 secured to mechanical holder 24 also rotate and as a consequence generate a movement of air.

In another embodiment, such as shown in FIG. 4B (two views are illustrated in FIG. 4B, the right side of FIG. 4B is a side view, and the left side of FIG. 4B is a front/back view), one or more fins 28 are securely attached to the outer periphery of ring 26 to create a movement of air when ring 26 rotates with a rotor shaft.

Similarly, FIG. 4C shows two views, with the right side of FIG. 4C being a side view, and the left side of FIG. 4C being a front/back view. As shown in FIG. 4C, one or more fins 28 are securely attached to the respective outer periphery of mechanical holder 24 and ring 26. Such an arrangement creates an airflow when mechanical holder 24 and ring 26 rotate with a rotor shaft.

FIG. 4 merely illustrates a few example arrangements for the fin structures. It is understood that the number of fins and the shape of these fins may not be limited to the arrangement shown in FIG. 4.

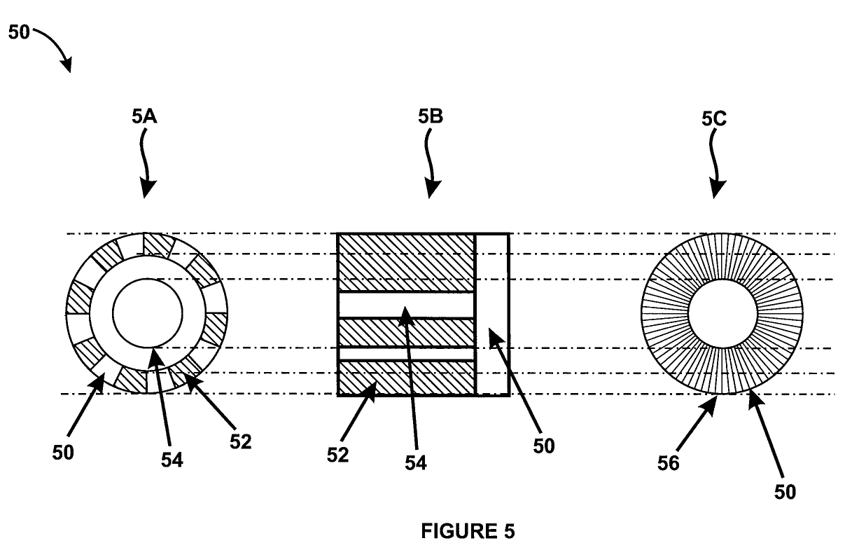

Capacitive sensors are well-known in the field. Generally, when two metal plates are placed with a gap between them and a voltage is applied to one of the plates, an electric field is formed between the plates. A capacitive sensor includes a detector plate connected to a voltage supply and a sensor plate that rotates with a rotor shaft (such as rotor shaft 12 of FIG. 1). FIG. 5 illustrates a capacitive sensor plate according to embodiments of the present invention. Specifically, FIGS. 5A and 5C are the front and back views of a capacitive sensor plate 50, while FIG. 5B is a side view of the sensor plate 50.

As shown in FIG. 5A, a circular holder 54 is securely fitted on an inner periphery of sensor plate 50. Circular holder 54 has a diameter less than the diameter of sensor plate 50. One or more fins 52 are disposed on an inner periphery of sensor plate 50 and securely attached to an outer circumference circling holder 54. In such an arrangement, circular holder 54 provides a common linkage for the one or more fins 52 to fit onto a rotor shaft. In operation, when sensor plate 50 rotates with the rotor shaft, the one or more fins 52 may create a movement of air. FIG. 5B is a side view of sensor plate 50 showing the one or more fins 52.

As shown in FIG. 5C, sensor plate 50 may include one or more sensor slots 56 (shown as the white slits in FIG. 5C) disposed on the other side of the sensor plate that is opposite to the side where the one or more fins 52 are disposed. Sensor slots 56 of a capacitive sensor are generally well-known in the art, and thus will not be discussed herein.

FIG. 5 is just an example arrangement of the fin structures. The number of fins and the shape of these fins may not be limited by the embodiment shown in FIG. 5.

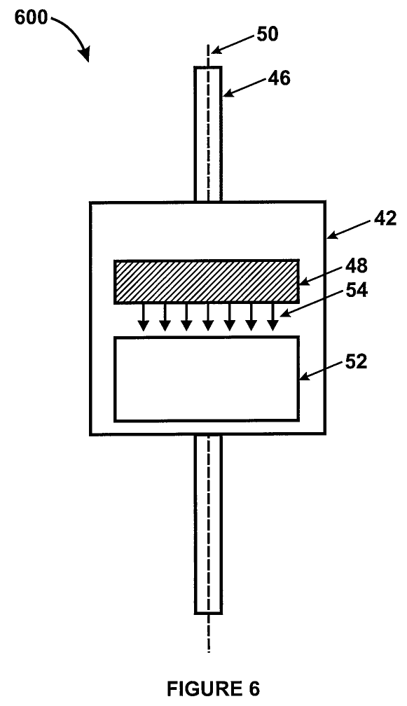

FIG. 6 is a simplified schematic representation of an electric motor system 600 according to an embodiment of the present invention. The various components depicted in electric motor system 600 are merely examples of components that may be included in an electric motor system. In alternate embodiments, electric motor system 600 may have less or more components than those shown in FIG. 6.

Referring to FIG. 6, electric motor system 600 includes a motor 42 secured to a rotor shaft 46. One or more fins 48 may be disposed within motor 42 and directly attached to shaft 46, which are substantially perpendicular to and rotate about an axis 50. Axis 50 passes through the center of shaft 46 and motor 42. A driver 52 may be disposed within motor 42 and may be located in close proximity to the one or more fins 48. When rotor shaft 46 rotates, fins 48 create a movement of air 54 that cools driver 52 directly and efficiently. Although FIG. 6 only shows a single fin 48, it will be appreciated that the number of fins and the shape of these fins are not limited by the embodiment shown in FIG. 6.

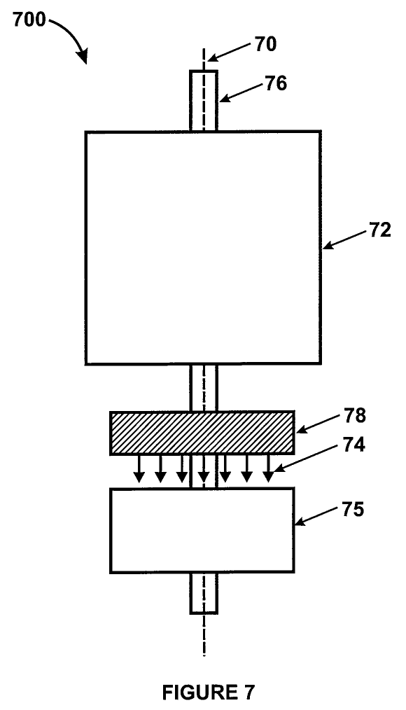

FIG. 7 is a simplified schematic representation of an electric motor system 700 according to an embodiment of the present invention. The various components depicted in electric motor system 700 are merely examples of components that may be included in an electric motor system. In alternate embodiments, electric motor system 700 may have less or more components than those shown in FIG. 7.

Referring to FIG. 7, electric motor system 700 includes a motor 72 secured to a rotor shaft 76. One or more fins 78 may be disposed outside motor 72 and directly attached to shaft 76, which are substantially perpendicular to and rotate about an axis 70. Axis 70 passes through the center of shaft 76 and motor 72. A driver 75 may be disposed outside motor 72 and may be located in close proximity to the one or more fins 78. When rotor shaft 76 rotates, fins 78 create a movement of air 74 that cools driver 75 directly and efficiently. Although FIG. 7 only shows a single fin 78, it will be appreciated that the number of fins and the shape of these fins are not limited by the embodiment shown in FIG. 7.

The various components depicted in FIGS. 1-7 are merely examples of components that may be included in an electric motor system. In alternative embodiments, the electric motor system may have less or more components than those shown in FIGS. 1-6. In addition, embodiments of the present invention may be applicable to different types of electric motors that are well-known in the art, such as brushed electric motors, brushless electric motors, and/or the like.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. An electric motor comprising:
a rotatable shaft;
a motor secured to the shaft for rotation about an axis of rotation;
a sensor coupled to the rotatable shaft, the sensor adapted and configured to detect a rotational position of the motor;
a driver coupled to the sensor to drive the motor responsive to the detected rotational position; and
one or more fins disposed within the sensor and adapted to produce a movement of air as the sensor rotates about the rotatable shaft around the axis of rotation during operation of the electric motor.

2. The electric motor of claim 1, wherein the sensor comprises an optical encoder.

3. The electric motor of claim 1, wherein the fins are attached to the optical encoder.

4. The electric motor of claim 3, wherein the fins are attached to an outer circumference of a holder in the optical encoder.

5. The electric motor of claim 1, wherein the fins produce a movement of air across the driver to cool the driver.

6. The electric motor of claim 3, wherein the fins are attached to an outer circumference of a circular ring in the optical encoder.

7. The electric motor of claim 1, wherein the sensor comprises a capacitive sensor having a sensor plate.

8. The electric motor of claim 7, wherein the fins are disposed on an inner periphery of the sensor plate.

9. The electric motor of claim 8, wherein the fins are attached to an outer circumference circling a holder, the holder disposed on an inner periphery of the sensor plate.

10. A system comprising:
a sensor to detect a rotational position of an electric motor; and
one or more fins disposed within the sensor and adapted to produce a movement of air.

11. The system of claim 10, wherein the sensor comprises an optical encoder.

12. The system of claim 11, wherein the fins are securely attached to the optical encoder.

13. The system of claim 10, wherein the sensor comprises a capacitive sensor having a sensor plate.

14. The system of claim 13, wherein the fins are attached to an outer circumference of a circular holder, the circular holder disposed on an inner periphery of the sensor plate.

15. The system of claim 10, wherein the movement of air produced by the one or more fins cools a electric motor driver.

16. A method for cooling an electric motor system comprising:
adapting a sensor onto a shaft for rotation thereabout;
disposing one or more fins on the sensor;
rotating the sensor about an axis of the shaft; and
producing a movement of air in the electric motor system as the sensor rotates about the axis of the shaft during operation of the electric motor system.

17. The method of claim 16, wherein disposing one or more fins on the sensor comprises attaching the one or more fins onto an optical encoder.

18. The method of claim 16, wherein disposing one or more fins on the sensor comprises attaching the one or more fins on a capacitive sensor plate.

19. An electric motor system comprising:
a rotatable shaft;
a motor secured to the shaft for rotation about an axis of rotation;
a driver coupled to the motor to drive the motor; and
one or more fins disposed in close proximity to the driver and attached to the rotatable shaft to produce a movement of air as the motor rotates about the rotatable shaft around the axis of rotation during operation of the electric motor.

20. The electric motor system of claim 19, wherein the movement of air produced by the one or more fins cools the driver during operation of the electric motor.
